(19) United States
(12) Patent Application Publication
(10) Pub. No.: US 2004/0003260 A1
(43) Pub. Date: Jan. 1, 2004

(54) System and method for audio tickets

(76) Inventors: Philip Hawkes, Burwood (AU); Gregory G. Rose, Concord (AU)

Correspondence Address: Qualcomm Incorporated, Patents Department, 5775 Morehouse Drive, San Diego, CA, 92121-1714, US

(21) Appl. No.: 10/186,379

(22) Filed: Jun. 27, 2002

(51) Int. Cl. H04L 9/00

(52) U.S. Cl. 713/185

(57) ABSTRACT

A system and method for digital tickets. An issuer provides a digital ticket to a portable wireless devices such as a sonic token, e.g., acoustic key fob or wireless telephone. The ticket can include a ticket index that may be encrypted. When entry is desired into an entity (such as a movie theater) whose access is controlled by a verifier, a user manipulates the token to wirelessly (e.g., acoustically) transmit the ticket index to the verifier, which grants access if the ticket is valid and has not previously been used or voided.

### RELATED APPLICATIONS

This application is related to co-pending U.S. patent application Ser. No. 10/077,365, filed Feb. 15, 2002, for an invention entitled “Method and Apparatus for Simplified Audio Authentication”, and is related to co-pending U.S. patent application Ser. No. 09/611,569, filed Jul. 7, 2000, for an invention entitled “Method and Apparatus for Simplified Audio Authentication”, both of which are incorporated herein by reference.

### FIELD OF THE INVENTION

The present invention relates generally to electronic tickets.

### BACKGROUND OF THE INVENTION

The above-identified patent applications disclose hand-held sonic-based “tokens” that a person can manipulate to transmit an acoustic signal representing secret information to a device, referred to as an “authenticator”, “verifier”, or “receiver”, to authenticate the person based on the signal. As recognized in those applications, the advantage of sonic-based tokens is that a large installed infrastructure already exists to receive and transmit sound and electronic signals derived from sound. Specifically, the global telephone system exists to transmit data representative of acoustic information, and apart from telephones many computing devices that are now linked by this same system (as embodied in the Internet) have microphones and speakers (or can easily be modified to have them).

As recognized herein, the tokens described in the above-referenced applications can be used to facilitate e-commerce that involves tickets. A ticket, of course, can be issued to a person who has paid for goods or services as proof that the person is entitled to the goods or services. For example, tickets are issued for travel, movie cinemas, entertainment parks, concerts, etc. Conventionally, tickets are in paper form but since it is now possible to buy almost anything on the Internet it has become common to issue so-called “e-tickets” that essentially are receipt numbers, booking numbers, or other examples of ticket indices sent to a purchaser over the Internet. To obtain the goods and services, the purchaser subsequently presents the ticket index in paper form to the vendor, who validates the index. While this is acceptable for some applications, such as for airline tickets, personal verification of an electronically obtained ticket index is too slow for many other applications, such as, e.g., gaining entry to a movie cinema or boarding a bus. Accordingly, the invention disclosed herein is provided.

### SUMMARY OF THE INVENTION

A method for access management includes an issuer generating a digital ticket associated with a verifier. The issuer is authorized by the verifier to generate such digital tickets. The method also includes providing the ticket to a portable mobile device, and then using the mobile device to transmit the digital ticket to the verifier. The transmission preferably is done wirelessly, and more preferably is done acoustically. Other wireless methods such as rf and IR can be used. Using the digital ticket, the verifier selectively grants access, wherein access denotes access to goods, services, data or whatever is associated with the digital ticket.

In a preferred implementation, prior to using the mobile device to acoustically transmit the digital ticket, the digital ticket can be encoded to render an audio ticket. The encoding can be undertaken by the issuer or by the mobile device.

In addition, prior to encoding, the digital ticket can be encrypted. The digital ticket is decoded and then decrypted, preferably by the verifier, to selectively grant access.

If desired, the digital ticket may be voided.

The preferred verifier selectively grants access, based on the digital ticket. Only if the digital ticket is valid (that is, generated by an authorized issuer), unused and unvoided will access be granted.

In another aspect, a system is disclosed for selectively granting access using digital tickets. The system includes an issuer issuing digital tickets, and a mobile device receiving a digital ticket. The mobile device transmits the digital ticket to the verifier to gain access if the verifier determines that the digital ticket is valid, and not previously used or voided.

In yet another aspect, a system includes an issuer including means for issuing digital tickets. A mobile device includes means for receiving a digital ticket. The mobile device also includes means for transmitting the digital ticket to the verifier to gain access. The verifier includes a means for receiving the digital ticket. The verifier also includes means for determining that the digital ticket is valid, and not previously used or voided.

In another aspect, a method for access management includes generating a digital ticket associated with a verifier, which in a specific embodiment can be referred to as a ticket management function (TMF). The digital ticket includes ticket data and at least one ticket index. The method also includes providing the ticket to a portable mobile device, and then using the mobile device to transmit the ticket index to the verifier. The transmission preferably is done wirelessly, and more preferably is done acoustically. Other wireless methods such as rf and IR can be used. Using the ticket index, the verifier selectively grants access to an entity that might be associated with the verifier.

In a preferred implementation, prior to using the mobile device to acoustically transmit the ticket index, the ticket index can be encoded to render an audio ticket. This audio ticket may be combined with the ticket data to render an audio ticket string. The encoding can be undertaken by the verifier or by the mobile device.

In addition, prior to encoding the ticket index can be encrypted to render a hidden index. The encryption can be undertaken using an encryption function having as input at least the ticket index, a nonce, and a secret encryption key. In this embodiment, the digital ticket includes the hidden index, nonce, and ticket data. The ticket index is decoded by the verifier or by an intermediary and then decrypted preferably by the verifier to selectively grant access.

The preferred TMF can selectively grant access by determining whether the ticket index matches an entry in a ticket database, and also, if desired, by determining whether the digital ticket already has been used. Only if the ticket index is valid and unused will access be granted.

In another aspect, a system is disclosed for selectively granting access using digital tickets. The system includes a ticket management function (TMF) issuing digital tickets, and a mobile device receiving a digital ticket. The mobile device transmits the digital ticket to the TMF to gain access to an entity associated with the TMF if the TMF determines that the ticket is valid and not previously used.

In yet another aspect, a system includes a verifier and means for issuing digital tickets, with each digital ticket including at least a ticket index and ticket data. A mobile device includes means for receiving a digital ticket. The mobile device also includes means for transmitting the digital ticket to the verifier to gain access to an entity associated with the TMF.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a general implementation, showing the ticket authorization structure;

FIG. 2 is a block diagram of the general implementation of FIG. 1, showing the ticket purchase structure;

FIG. 3 is a block diagram of the general implementation of FIG. 1, showing the ticket presentation structure;

FIG. 4 is a block diagram schematically showing the ticket issuing process of a specific implementation;

FIG. 5 is a block diagram schematically showing the ticket issuing process for encrypted tickets for the specific implementation of FIG. 4; and

FIG. 6 is a block diagram schematically showing the ticket presentation process for the specific implementation of FIG. 4.

### DETAILED DESCRIPTION OF THE PREFERRED EMBODIMENT

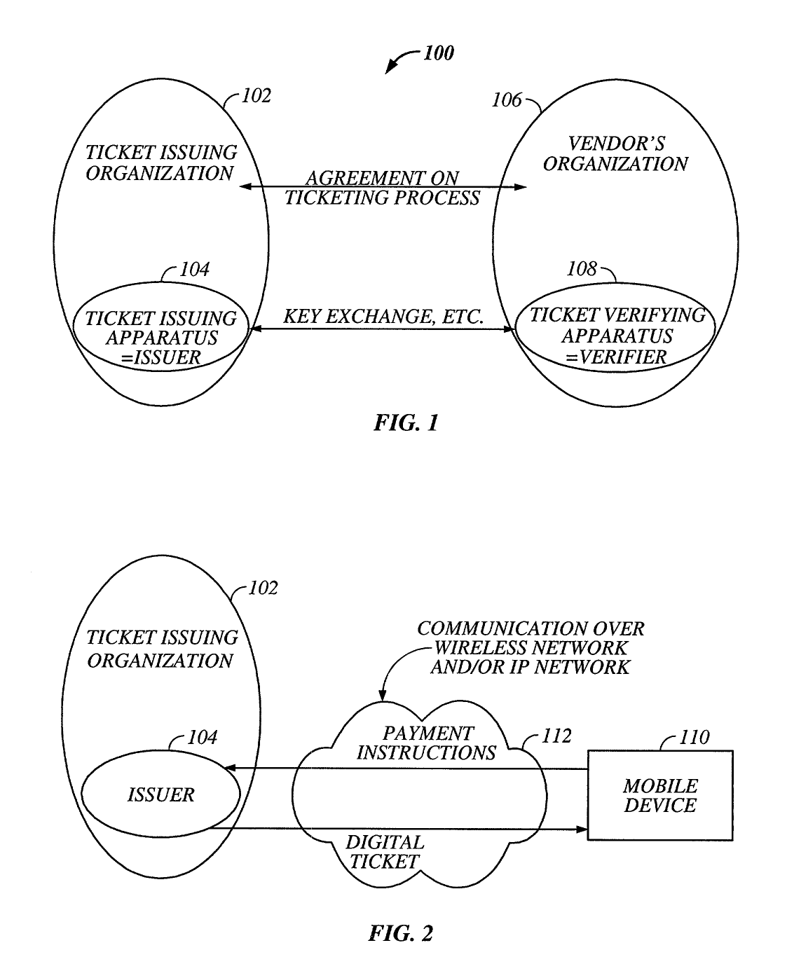

Referring initially to FIG. 1, a system is shown, generally designated 100, for providing audio tickets to mobile devices. As shown, a ticket issuing organization 102 can include a ticket issuing apparatus or issuer 104 that issues tickets to a vendor organization 106. The vendor organization 106 can include a ticket verifying apparatus or verifier 108 that exchanges the below-described encryption keys with the issuer 104. As indicated in FIG. 1, the ticket issuing organization 102 and vendor organization 106 can negotiate an agreement on the ticket issuing process, i.e., how, when, and where tickets can be issued. If desired, the ticket issuing organization 102 and vendor organization 106 can be embodied by a single entity, referred to below as a ticket management function (TMF).

FIG. 2 indicates that the issuer 104 issues digital tickets to one or more mobile devices 110 over a wired or wireless network 112 that can be an Internet Protocol (IP) network if desired or sonic network or other network. As indicated in FIG. 2, payment instructions can be exchanged between the issuer 104 and mobile device 110 to facilitate payment for tickets by the device 110 by, e.g., credit card or debit card transactions.

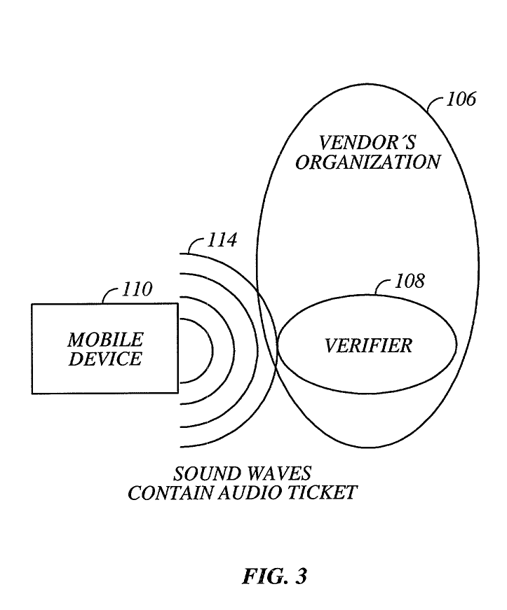

When the user of the mobile device 110 wishes to gain entry to an entity associated with the verifier 108, FIG. 3 shows that the mobile device 110 transmits the ticket in the form of sound waves 114 to the verifier 108, although other transmission paths such as infrared or radiofrequency could be used. Thus, the ticket can be thought of as an audio ticket. Pending successful validation of the ticket as described below, the verifier 108 grants access to the entity to the user of the mobile device 110.

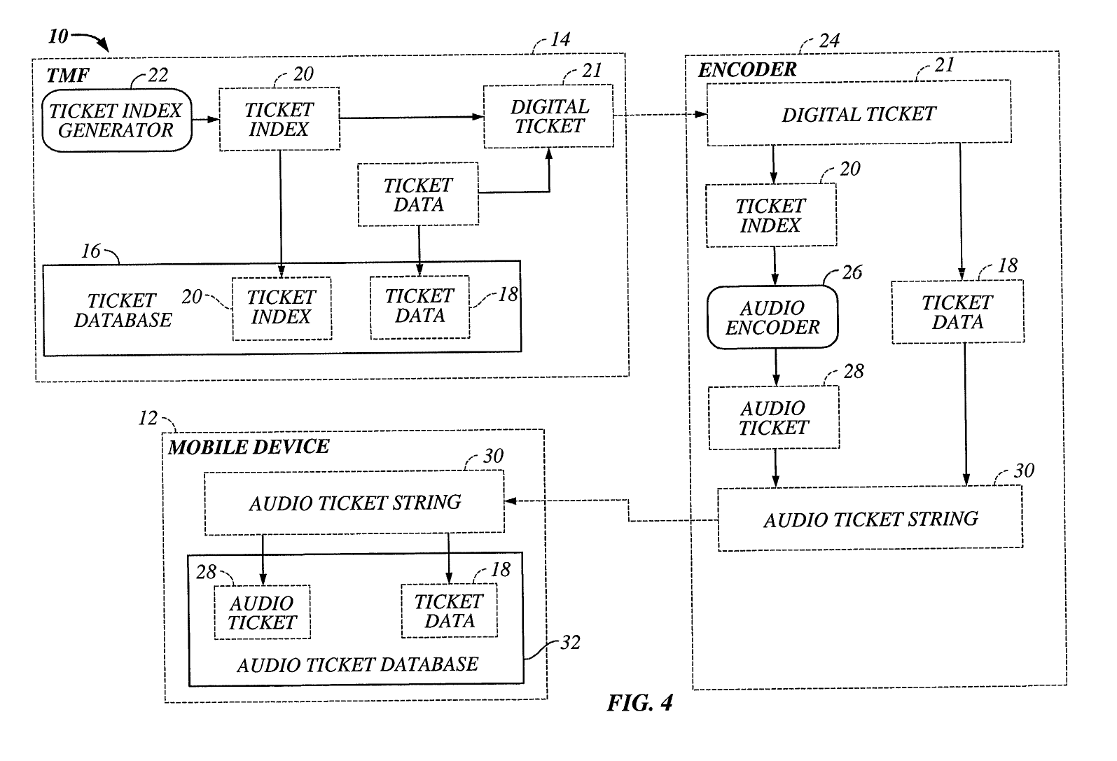

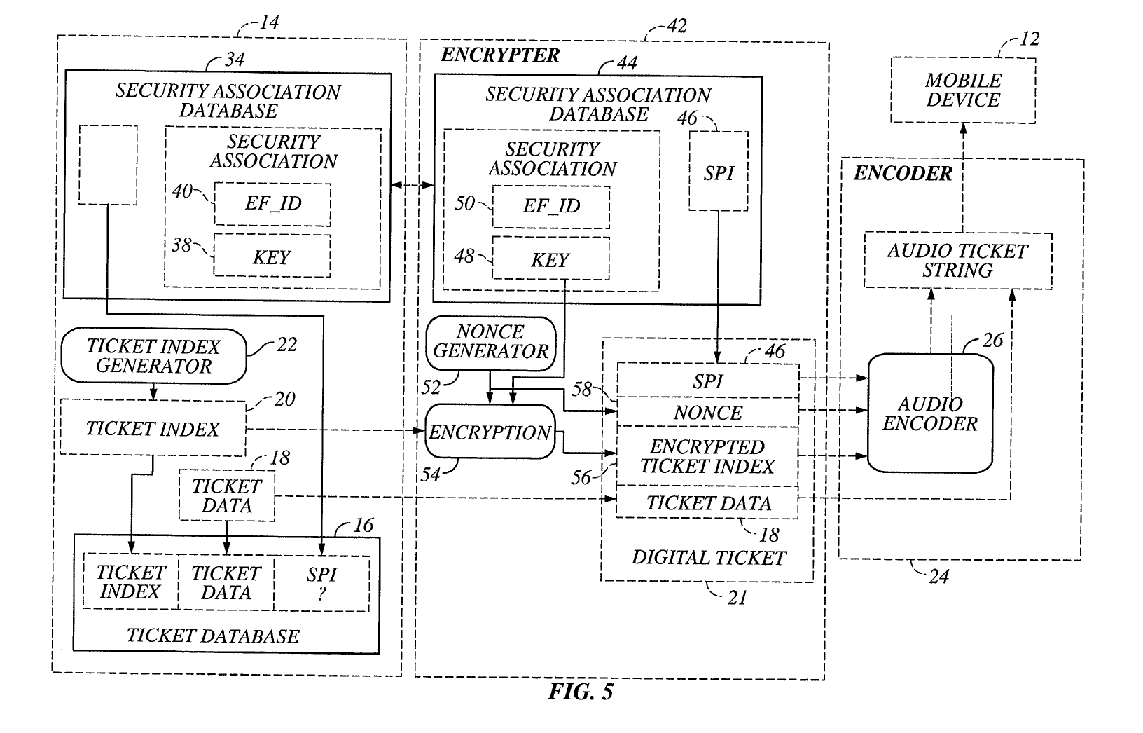

FIG. 4 shows a specific implementation of the present system, generally designated 10, in which the vendor organization and issuing organization are conflated in a ticket management function. Specifically, the system 10 includes a portable hand-held mobile device 12 that can be configured as a key fob or other small device. The present invention, however, applies to other mobile device configurations, such as mobile communication stations including laptop computers, wireless handsets or telephones, data transceivers, or paging and position determination receivers that can be hand-held or portable as in vehicle-mounted (including cars, trucks, boats, planes, trains), as desired. Wireless communication devices are also sometimes referred to as user terminals, mobile stations, mobile units, subscriber units, mobile radios or radiotelephones, wireless units, or simply as “users” and “mobiles” in some communication systems. In a preferred embodiment, the mobile device 12 emits an acoustic signal. The principles advanced herein can apply, however, to other wireless communication principles, including radiofrequency (e.g., Bluetooth), infrared, and optical transmission. Less preferably, the mobile device 12 can be connected to the below-described ticket management function using, e.g., a USB connection. For disclosure purposes, the figures will be discussed in terms of audio wireless transmission principles.

The purpose of the present invention is to permit a ticket management function (TMF) 14 to issue digital tickets to the mobile device 12 in response to, e.g., a transaction between a user of the mobile device 12 and TMF 14 over the Internet, so that the user of the mobile device 12 can later present the digital tickets to gain access to entities controlled by the TMF 14. The particular transaction that triggers ticket issuance may be a credit card transaction or other transaction, in person or online. This embodiment is not limited to transactions that are monetary in nature, however. For example, the transaction could include the user providing evidence of a security clearance.

Without loss of generality, the TMF 14 can be implemented by a computer or network of computers that contain hardware- or software-implemented functions described in the block diagrams herein. Also, the verifier 108 (FIG. 1)/TMF 14 (FIG. 4) can be implemented by a computer or network of computers that contain hardware- or software-implemented logic described herein.

The particular entity, access to which is controlled by the TMF, can take any suitable form, e.g., the entity might be a movie theater, with successful presentation of a digital ticket resulting in the automatic or manual unlocking of an entrance door. The principles advanced herein are independent of the particular entity associated with the TMF 14 and are independent of the actual transaction that results in ticket issuance.

As set forth further below, the digital ticket transmitted from the mobile device to the verifier may contain a description what the user is entitled to. Alternatively, the digital ticket may contain a booking number used to reference a description of what the user is entitled to. To prevent an attacker from guessing the digital ticket, at least a portion of the digital ticket should be hard to predict in accordance with disclosure below. This hard-to-predict portion may include a message authentication code or random bits.

The digital tickets may be provided to the user of the mobile device 12 by voice, printed paper, or email (for input of the tickets into the mobile device 12 by a user) or automatic transmission (for direct input into the mobile device 12) over, e.g., an IP network, wireless network, or even using sound tones. The tickets might first be sent to a computer for subsequent downloading into the mobile device 12. Preferably, provision of digital tickets is done using encryption and authentication, for enhanced security.

As discussed in greater detail below, the digital tickets may include or have attached a public-key-cryptography-based digital signature provided by the issuer 104 (FIG. 1)/TMF 14 (FIG. 4). This signature can be in accordance with the FIPS standard DSS regarding digital signatures. The mobile device 12 performs certain operations on the digital ticket and digital signature, and is thus able to verify that issuer provided the digital ticket. Moreover, in the event of a dispute, any one can use the digital signature to prove that the issuer provided the digital ticket.

Turning to the details of FIG. 4, as shown the TMF 14 can include a ticket database 16 that stores ticket data 18 indexed by ticket indices 20. Thus, each preferred, non-limiting digital ticket 21 includes ticket data, i.e., information regarding what the ticket is for (e.g., entry into a particular entity or group of entities), along with a ticket index, also referred to as a booking number or ticket number. However, “digital ticket” can refer simply to the ticket index. If desired, a single ticket might be assigned more than one ticket index, so that if need be the same ticket, in the form of its indices, may be transmitted more than once (e.g., a second time for confirmation) without having to use the same index and, hence, give an eavesdropper the opportunity to re-use a ticket.

The ticket indices are generated by a ticket generator 22. To prevent an attacker from guessing the ticket index, the ticket generator 21 can establish the index for each ticket by establishing a numeric part of each index that increases serially from the previous ticket index but that also has a hard-to-predict message authentication code appended to it. Or, the ticket generator can simply establish random ticket indices.

The digital tickets 21 may be provided to the user of the mobile device 12 by voice, printed paper, or email (for input of the tickets into the mobile device 12 by a user) or automatic transmission (for direct input into the mobile device 12) over, e.g., an IP network, wireless network, or even using sound tones. The tickets might first be sent to a computer for subsequent downloading into the mobile device 12. Preferably, provision of tickets is done using encryption, for enhanced security.

In one embodiment, the tickets 21 can be processed by a software- or hardware-embodied encoder located at the TMF 14 or mobile device 12 or separately therefrom. In the embodiment shown in FIG. 4, the encoder 24 sends the ticket index 20 (or at least a transmitted portion thereof) to an audio encoder 26 to render a digital audio ticket 28. The audio ticket 28 is combined with the ticket data 18 as shown to render an audio string 30. Essentially, the audio encoder 26 converts an electrical signal representing the ticket index 20 into an audio file in, e.g., MP3 or .WAV format. If desired, the audio encoder 30 can use audio error correction principles known in, e.g., the CDMA art. In any case, the mobile device 12 stores the audio ticket string 30, which includes the audio ticket 28 and ticket data 18, in an audio ticket database 32.

FIG. 5 shows additional components that can be provided in some preferred applications to enhance security by encryption, preferably by symmetric key encryption. Both the encryption function and key may change from time to time, for example, if a key is compromised. Moreover, it may be that the TMF 14 serves more than one entity, in which case a unique key should be provided for each entity.

In such an embodiment, an IPSec or IPSec-like protocol can be used in which the TMF 14 can include a security association (SA) database 34 that in turn includes a security parameter index (SPI) 36. The security association database 34 includes both secret encryption key(s) 38 that are indexed by the SPI 36 and encryption function IDs 40, which indicate the identities of encryption functions to be used with particular keys. Different keys 38 can be used for different vendors and for different departments within the same vendor. In any case, it should be understood that the TMF 14 selects the appropriate key and encryption for the particular application.

An encrypter 42 communicates with the TMF 14. Like the TMF 14, the encrypter 42 includes an SA database 44 that in turn includes an SPI 46 and associated secret encryption key(s) 48 and encryption function IDs 50. To establish the content of its SA database 44, the encrypter 42 negotiates with the TMF 14 a security association in accordance with principles known in the art. That is, the TMF 14 and encrypter 42 determine which keys, encryption functions, and associated SPIs will be used from the TMF.

As recognized by the present invention, encryption should precede encoding. Accordingly, when the mobile device 12 encodes the ticket index, it may also embody the encrypter 42, and indeed may encrypt and then encode the ticket index just prior to transmission to gain access. On the other hand, if the TMF 14 performs the above-described encoding, it may embody the encrypter 42, in which case the TMF 14/encrypter 42 need not perform negotiation but need only initialize a common SA. It is to be understood that while one preferred, non-limiting encryption method is disclosed herein, other methods can be used in accordance with encryption principles known in the art without departing from the scope of the present invention.

As shown, the encrypter 42 may include a nonce generator 52 that generates nonces. An encryption engine 54 receives as input a nonce from the nonce generator 52 and a secret encryption key 48 from the SA database 44, as well as the ticket index 20, and in accordance with encryption principles known in the art uses the appropriate encryption function (such as, e.g., DES) to combine the nonce, key, and ticket index to render an encrypted ticket index 56. In the encryption embodiment, the encrypted ticket index 56, also referred to as a “hidden” index, is sent along with the SPI 46, nonce 58, and ticket data 18 (collectively establishing a digital ticket 21) to the encoder 24 for producing from the SPI, nonce, and encrypted ticket index 56 the audio string 30 in accordance with principles discussed above.

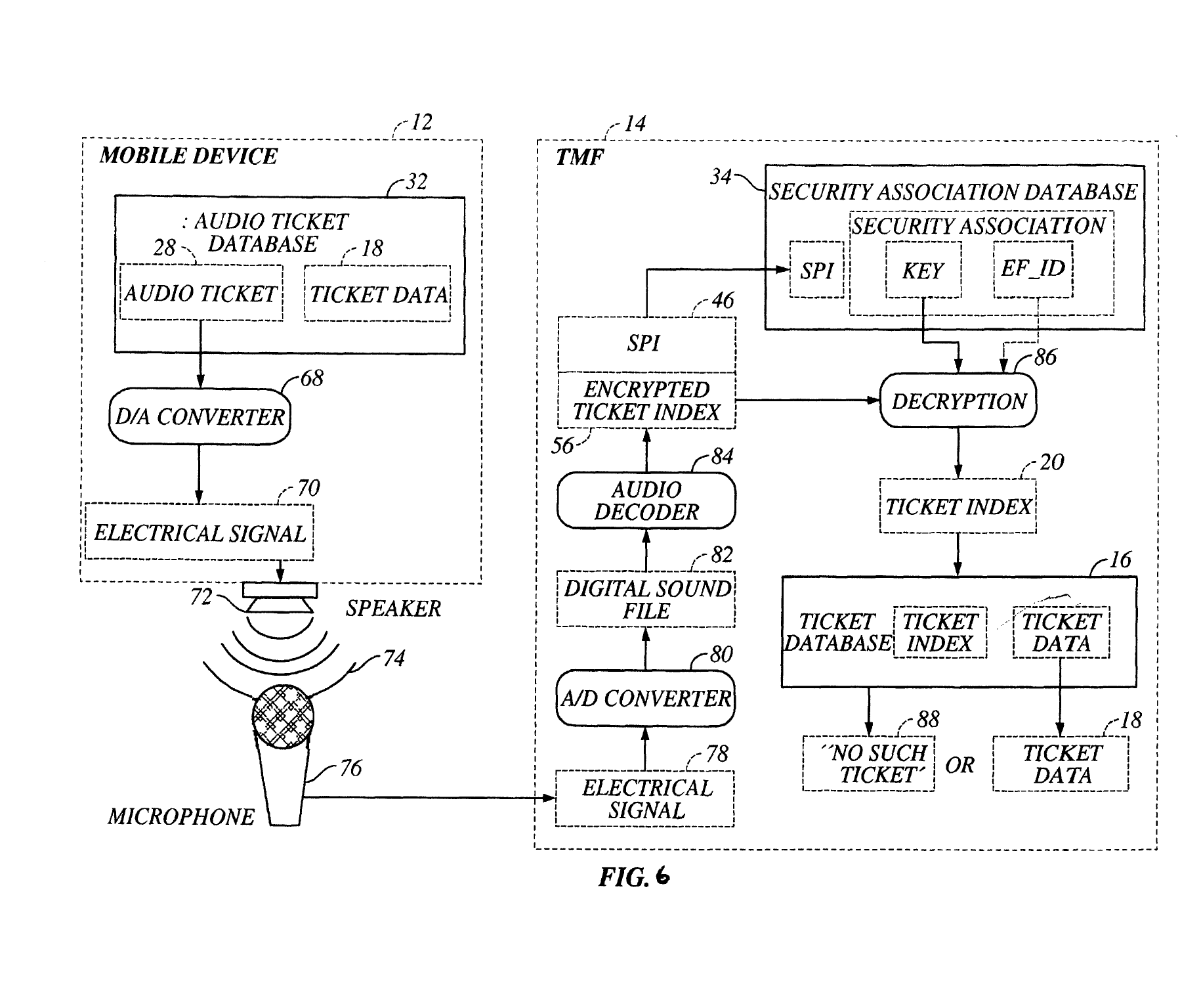

Having described how digital tickets are generated and, if desired, encrypted and encoded, attention is now drawn to FIG. 6, which discloses further components of the preferred TMF 14 and mobile device 12 that are used when a ticket is to be presented for access, and which assumes, for completeness, that encryption has been employed. When a user desires access to an entity associated with the TMF 14, the user selects the appropriate ticket (with ticket index) using any convenient mobile device 12 input apparatus (e.g., keypad) and then manipulates the mobile device 12 as appropriate to transmit the ticket index.

More specifically, the mobile device 12 includes a digital-to-analog converter (DAC) 68, which, in response to a user appropriately manipulating the mobile device 12, modulates the audio file represented by the audio ticket 28 into an electrical signal 70 that is transformed by a speaker 72 to wireless format, i.e., to sound waves 74 in the preferred acoustic embodiment shown. The sound waves 74 can be similar to modem beeps.

The sound waves 74 are detected and transformed by a microphone 76 into an electrical signal 78. The electrical signal 78 is demodulated by an analog-to-digital converter (ADC) 80 to produce a digital audio file 82, e.g., a .WAV- or MP3-formatted file. The file is decoded by an audio decoder 84 that is the inverse of the audio encoder 26 of the mobile device 12 shown in FIG. 4. The microphone 76, ADC 80, and decoder 84 can be part of the TMF 14 as shown, or can be implemented by a component that is separate from but in communication with the TMF 14. For instance, the microphone 76 might be a telephone microphone, so that a user could present the ticket to the TMF 14 over the phone.

Once decoded, the resulting encrypted ticket index is sent to a decryption engine 86, which operates inversely to the encryption engine 54 shown in FIG. 5. To decrypt the encrypted ticket index and render the ticket index 20, the decryption engine 86 accesses, using the SPI 46, the appropriate key and encryption function from the SA database 34, and then decrypts the ticket index 20.

Once decrypted, the ticket index 20 is used by the TMF 14 to selectively grant access to the entity to which the ticket index corresponds. To do this, the TMF 14 can first determine whether the ticket index 20 is valid by determining whether it exists in the ticket database 16. If the ticket index is valid, the TMF 14 can determine whether the ticket index 20 has been used already (as might be indicated by, e.g., a “used” flag), and if so, deny access. Both of these determinations can be conflated to a single step by deleting a ticket index from the ticket database 16 after first use. In any case, for a valid ticket, the corresponding ticket data 18 is returned/otherwise executed or followed to grant the appropriate access. Otherwise, access is denied by, e.g., returning “no such ticket” at 88. If desired, if the ticket index is not initially found, the TMF 14 can request the mobile device 12 to retransmit, in which case one of the alternate ticket indices associated with the ticket (as mentioned above) can be transmitted.

In addition to the above, if desired, to foil a “false attack” that might arise by an eavesdropper controlling the receiving microphone and intercepting a ticket for later reuse, authentication information (e.g., time and/or location) can also be transmitted by the mobile device 12 and checked by the TMF 14 before granting access.

In some cases, there may be a large set of verifiers/TMF that will accept a particular digital ticket 21. One such example is a bus ticket, which may be presented on any number of busses.

The user may decide that he no longer requires the access associated with the digital ticket 20. In this case, the digital ticket can be voided, which would typically require informing the potential verifiers 16 that the digital ticket is no longer valid.

It may now be appreciated that the present invention affords many advantages in addition to relieving the user of having to carry and manage perhaps dozens of paper tickets. The audio ticket can be presented and processed in a fraction of a second without requiring authenticating personnel at the TMF 14. The audio ticket can be provided to a user almost anywhere in the world, again in a matter of a fraction of a second. When the mobile device 12 is a mobile phone, the user need not carry any additional hardware apart from the phone. Since many computers already are configured to receive and process audio and/or IR signals, no additional infrastructure is required to use the present tickets. When audio tickets are used, each vendor may select its own standard of encoding, since any encoding method can be used. Moreover, it is possible to enable a user to confirm the validity/authenticity of a ticket, and to send an audio ticket to another person for use. The present tickets can be ordered, paid for, and used while the user remains mobile.

While the particular SYSTEM AND METHOD FOR AUDIO TICKETS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. '112, sixth paragraph, unless the element is expressly recited using the phrase “means for” or, in the case of a method claim, the element is recited as a “step” instead of an “act”.

What is claimed is:

1. A method for access management, comprising:
generating at least one digital ticket associated with a verifier;
providing at least a portion of the digital ticket to a portable mobile device;
using the mobile device to acoustically transmit at least a portion of the digital ticket to the verifier; and
using at least the portion, selectively granting, to a user of the mobile device, access to an entity associated with the verifier.

2. The method of claim 1, further comprising:
prior to the act of using the mobile device to acoustically transmit, encoding at least a transmitted portion of a ticket index to render an audio ticket.

3. The method of claim 2, further comprising combining the audio ticket with the ticket data to render an audio ticket string.

4. The method of claim 2, wherein the act of encoding is undertaken by the verifier.

5. The method of claim 2, wherein the act of encoding is undertaken by the mobile device.

6. The method of 2, further comprising encrypting at least one of: a ticket index associated with the ticket, and ticket data associated with the ticket, prior to the act of encoding.

7. The method of claim 6, comprising encrypting the ticket index to render a hidden index.

8. The method of claim 7, comprising encrypting the ticket index using an encryption function having as input at least the ticket index, a nonce, and a secret encryption key.

9. The method of claim 8, wherein the digital ticket includes at least the hidden index, nonce, and ticket data.

10. The method of claim 2, comprising decoding the audio ticket at the verifier to facilitate the act of selectively granting.

11. The method of claim 7, comprising decrypting the hidden index at the verifier to facilitate the act of selectively granting.

12. The method of claim 1, wherein the verifier undertakes the act of selectively granting by:
determining whether at least the portion of the digital ticket matches at least one entry in a database accessible to the verifier;
determining whether the digital ticket has been used; and
only if the portion matches at least one entry in the database and the ticket has not yet been used or voided, granting access to the entity.

13. The method of claim 1, comprising voiding the ticket.

14. The method of claim 13, wherein the digital ticket is voided by informing at least one verifier that the digital ticket is voided, wherein the at least one verifiers includes all verifiers that could selectively grant access based on the digital ticket.

15. A system for selectively granting access using digital tickets, comprising:
at least one issuer issuing digital tickets; and
at least one mobile device receiving at least one digital ticket, the mobile device transmitting the digital ticket to a verifier to gain access to an entity associated with the verifier if the verifier determines at least that the ticket is valid.

16. The system of claim 15, wherein the mobile device wirelessly transmits the ticket to the verifier.

17. The system of claim 16, wherein the mobile device acoustically transmits the ticket to the verifier.

18. The system of claim 15, wherein prior to using the mobile device to transmit the ticket, at least a portion of the ticket is encoded to render an audio ticket.

19. The system of claim 18, wherein the audio ticket is combined with ticket data to render an audio ticket string.

20. The system of claim 19, wherein the audio ticket string is generated by the issuer.

21. The system of claim 19, wherein the audio ticket string is generated by the mobile device.

22. The system of 18, wherein the issuer encrypts at least one of: the ticket index, and the ticket data, prior to encoding the ticket index.

23. The system of claim 22, wherein the ticket index is encrypted to render a hidden index.

24. The system of claim 23, wherein the ticket index is encrypted using an encryption function having as input at least the ticket index, a nonce, and a secret encryption key.

25. The system of claim 24, wherein the digital ticket includes at least the hidden index, nonce, and ticket data.

26. The system of claim 18, wherein the verifier decodes the audio ticket after transmission by the mobile device.

27. The system of claim 23, wherein the verifier decrypts the hidden index.

28. A system comprising:
at least one ticket management function (TMF) including means for issuing digital tickets, each digital ticket including at least a ticket index; and
at least one mobile device including means for receiving at least one digital ticket, the mobile device further including:
means for transmitting the digital ticket to the TMF to gain access to an entity associated with the TMF.

29. The system of claim 28, wherein the means for transmitting includes acoustic means for transmitting.

30. The system of claim 29, wherein the TMF includes means for using the digital ticket to selectively grant, to a user of the mobile device, access to the entity.

31. The system of claim 30, further comprising:
means for, prior to invoking the means for transmitting, encoding the ticket index to render an audio ticket.

32. The system of claim 31, further comprising means for combining the audio ticket with ticket data to render an audio ticket string.

33. The system of claim 32, wherein the means for encoding and combining are executed by the TMF.

34. The system of claim 32, wherein the means for encoding and combining are executed by the mobile device.

35. The system of 30, further comprising means for encrypting at least one of: the ticket index, and the ticket data.

36. The system of claim 30, comprising means for encrypting the ticket index to render a hidden index.

37. The system of claim 36, comprising means for encrypting the ticket index using an encryption function having as input at least the ticket index, a nonce, and a secret encryption key.

38. The system of claim 37, wherein the digital ticket includes at least the hidden index, nonce, and ticket data.

39. The system of claim 31, comprising means for decoding the audio ticket at the TMF.

40. The system of claim 35, comprising means for decrypting the hidden index at the TMF.

41. The system of claim 30, wherein the TMF includes:
means for determining whether at least a portion of the digital ticket matches at least one entry in a database accessible to the TMF;
means for determining whether the digital ticket has been used; and
means responsive to the determining means for granting access to the entity.

42. The system of claim 15, comprising means for voiding the ticket.
